(19) United States
(12) Patent Application Publication
(10) Pub. No.: US 2026/0159426 A1
(43) Pub. Date: Jun. 11, 2026

(54) PRESSURIZED CARTRIDGE OF CONCENTRATED MINERAL SOLUTION

(71) Applicant: Aqvita SRL, Brussels (BE)

(72) Inventor: Philippe TOB, Uccle (BE)

(21) Appl. No.: 18/706,969

(22) PCT Filed: Nov. 4, 2022
(86) PCT No.: PCT/EP2022/080797

§ 371 Date: May 2, 2024

(30) Foreign Application Priority Data
Nov. 4, 2021 (LU) LU500826

(51) Int. Cl. C02F 1/68; A23L 2/54; A23L 2/60

(52) U.S. Cl. CPC C02F 1/686; A23L 2/54; A23L 2/60; C02F 2201/006

(57) ABSTRACT

The invention relates to the field of the production of mineral water, from concentrated mineral solutions. The concentrated solutions of minerals are provided in a pressurized cartridge under a pressure of propellant gas (4) comprising CO₂. This ensures the stability of the solution over time, and is a convenient consumable.

The invention relates to the field of the production of sweetened (sweet) water, from concentrated mineral solutions (which is here different from flavours, sugar or sweetener/edulcorant addition). For the purpose of the disclosure sweetened (water (or sweet water) refers to water that has been mineralized, with the aim of obtaining water that has a pre-determined sensory quality and composition. Prior to mineralization, the water can have been partially or totally stripped of certain species, in particular minerals, like for example desalted sea water. The process of sweetening saltwater was used in patent U.S. Pat. No. 3,093,975A (Zarchin Alexander).

WO2019/020221 discloses a method and the associated apparatus to produce instantaneously sweetened water from tap water. The mineralisation is not a random mineralisation but aims a providing a water with predetermined amounts of minerals, like in a branded mineral water. This method includes:
eliminating the impurities of the tap water to obtain purified water;
at least partially demineralising the purified water by selective removal of the minerals;
remineralising the demineralised water by injection of a predetermined volume of a concentrated solution comprising at least one mineral element that is lacking to readjust the mineralisation to the predetermined content and predetermined sensorial quality;
collecting the remineralised water.
   These steps are performed in line, the water flows continuously, and the volume of concentrated solutions is regularly injected until the water stops flowing (the demand from the user stops. Fluidic micro-feeding device like a pump or a micro-feeding valve are disclosed to supply the concentrated solution stored in a reservoir in the flow of water to remineralize. Other similar systems exist on the market also involving the use of pumps and reservoirs of concentrated mineral solutions. However, the use of such reservoirs coupled to pumps to feed the concentrated solution into the waterflow present a number of disadvantages.
   A first problem is the instability of the solutions in the reservoir, especially when the solutions contain so called “sparingly soluble salts”. It is advised to store such solutions in a closed container and at low temperatures to avoid any loss of dissolved CO₂ which could lead to precipitation of minerals in the solutions. Indeed, concentrated solutions are often supersaturated. A high concentration of minerals is achieved thanks to a high content of CO₂ dissolved in the concentrated solution that maintains an equilibrium to ensure solubilisation. However, when the solution loses some CO₂, the carbonates equilibrium in the solution is displaced leading to destabilisation of the whole mineral equilibrium.
   This problem further appears during the operation of the pumps. For installing the pump, the length of tubing between the cartridge and the water flow is not null. The pump carries CO₂ along the concentrated solution, which can lead to precipitation of minerals in the tubing, thereby biasing or blocking the inlet of concentrated solution in the water flow. This leads to a large on error the remineralisation of water to the predetermined mineral content. This problem may also appear when the concentrated solution is injected in a batch-like water saturator that enables to carbonate water.
   The applicant has therefore judged necessary to develop a solution to the above problem of stability of the concentrated solution and the reliability of input of this solution into the water to remineralize.

### Solution According to the Invention

For this purpose, the present invention proposes a pressurized cartridge containing a concentrated solution of minerals under a pressure of propellant gas comprising CO₂.

Preferably, the concentrated solution of minerals comprises at least one bicarbonate mineral species at a supersaturation concentration, a saturation concentration or close to its saturation concentration.

The pressurized cartridge does not contain any solid, and in particular does not contain any mineral in solid form.

The propellant gas contains CO₂ having a dual function: being a propellant and preventing precipitation of salts. The solubility of the minerals in the concentrated solution is very sensitive to the amount of CO₂ dissolved in the solution, where hydrated CO₂ reacts with water and further decomposes in bicarbonate, carbonate and H+ ions. Low changes in CO₂ concentration may lead to precipitation of minerals, and especially (super) saturated minerals and affect the effective concentration of the solution. The presence of CO₂ under pressure above the solution ensures that the concentration of CO₂ within the solution is always at equilibrium. Upon sampling out solution from the cartridge, the pressure of CO₂ will only be modified to a minor extend which will ensure a stable concentration of CO₂ within the saturated solution of minerals.

A cartridge here designates any container suitable to contain at least some gas under pressure. The cartridge is a flow-out cartridge, like for example of the aerosol or siphon type, and not a flow-through type cartridge, i.e. water to mineralize cannot flow through the cartridge of the invention, but the cartridge is arranged with an outlet allowing an amount of its content to flow out of the cartridge, without being replaced by any incoming fluid.

Preferably, the cartridge is an aerosol cartridge.

Further, compared to many other propellants, CO2 is not toxic and will not adversely contaminate the saturated solution of minerals which is for preparing water for human use. Its pressure inside a container is less affected by temperature and does not have a cooling effect caused by evaporation when liquified gas as used as propellants. It therefore avoids the risk of any aqueous solution freezing upon leaving the cartridge.

As mentioned above, in the present invention, CO₂ has more than just a propellant function. It plays an essential stability role, to maintain de (super) saturated bicarbonates in solution and ensure a reproducibility ad durability of the discharge concentration over the repeated use if the cartridge, even when it becomes almost empty. It is the combination of dissolved bicarbonates at high concentration and gaseous carbon dioxide under pressure that is the essence of the invention. It is to be noted that for many applications, CO2 is not suitable as propellant, as it leads to a too low pH that would degrade the liquid content of cartridges. This is in particular true for flavour or sugary solutions cartridges.

Advantageously, the ratio of CO₂ within the propellant gas depends on the pH of the concentrated solution of minerals.

In a particular embodiment, the propellant gas consists of CO₂.

The pressure in the cartridge (pressure of propellant gas) is preferably comprised between 35 psi and 100 psi, preferably between 50 psi and 90 psi, preferably between 60 and 85 psi, and still preferably between 70 psi and 80 psi, for proper misting of the entire liquid content of the cartridge.

The pressurized cartridge of the invention is for sweetened water, i.e. for introducing some of the concentrated solution of minerals it contains into water (tap water, demineralized water, . . . ) to produce drinkable water. The term sweetened does not refer here to the addition of sugar, edulcorants or sweeteners, but to the addition of minerals. The sweetened water produced preferably has a predefined mineral composition. This implies that no toxic element, whether gas, solvent or mineral, is introduced in the cartridge. In particular, the content of the cartridge is for producing drinkable water with an accurate and controlled calcium and/or magnesium content.

Preferably, the concentrated solution of minerals comprises minerals usually present in natural mineral waters that are highly valued by consumers. These types of natural mineral waters are formed naturally in geologic formations where relatively insoluble minerals (sparingly soluble salts) such as calcite and dolomite are dissolved slowly over long periods of time. The weathering of these natural rocks charges natural waters with bicarbonates, hydroxylates, chlorides and/or sulfates. Preferably, the concentrated solution of minerals comprises at least a sparingly soluble salt. Sparingly soluble salts are well known in the art of water mineralization. They are usually defined as salts having molar solubility of much less than 1 mol/L. They can be bicarbonate salts. They are for 25 example calcium and/or a magnesium salts. They can be found for example in calcite and dolomite.

Preferably, the concentrated solution of minerals comprises calcium bicarbonate and/or the magnesium bicarbonate.

Preferably, the concentrated solution of minerals contains at least one bicarbonate mineral species (of a sparingly soluble salt) at a supersaturation concentration or close to its saturation concentration, i.e. for example less than 10% below its saturation concentration.
Saturated or super saturated solution are particularly unstable, and have a strong tendency to precipitate. In particular, as soon as they are in contact with open atmosphere, dissolved CO₂ evaporates, thereby breaking the equilibrium and causing dissolved bicarbonates to reprecipitate. This results in altering the accuracy the amount of minerals injected out of the cartridge by both modifying the dissolved concentration of the solution of minerals and blockage of the cartridge outlet. This is why is it important to maintain the pressure of CO₂ above the (super) saturated solutions to ensure the stability of the biphasic content of the cartridge.
For example, the concentrated solution of minerals can contain between 0 and 110 000 ppm of magnesium, preferably between 1000 and 100 000 ppm, preferably between 2000 and 65000 ppm, still preferably between 3500 and 55000 ppm, still preferably between 10000 and 40000 ppm of magnesium.
The concentrated solution of minerals can contain between 0 and 350000 ppm of calcium, preferably between 5000 and 175000 ppm, preferably between 10000 and 80000 ppm, still preferably between 20000 and 55000, still preferably between 30000 and 40000 ppm. Calcium and magnesium
Preferably, the concentrated solution of minerals comprises at least one salt of the list consisting of magnesium sulfate (MgSO₄), magnesium carbonate (Mg^{CO}₃), magnesium nitrate (MgNO₃), calcium nitrate (Ca(NO₃)₂), calcium carbonate (CaCO₃), sodium chloride (NaCl), sodium bicarbonate (NaHCO₃), potassium bicarbonate (KHCO₃), calcium hydroxide (Ca(OH)₂) and magnesium hydroxide (Mg(OH)₂) (the above list referring to the solid form of said salt).
Within the cartridge, some carbon dioxide dissolves in the concentrated solution of minerals and reacts with water to form carbonic acid, bicarbonate, carbonate and H+.
Preferably, the pH of the concentrated solution is comprised between 1 and 8, preferably between 2 and 7.8, still preferably between 3 and 7.5, and in some embodiments, even below 7.

The concentrated solution of minerals is a liquid phase within the cartridge. Preferably, this liquid phase occupies up to 90% of the volume of the cartridge, preferably up to 85% of the volume of the cartridge or up to 80% of the volume of the cartridge.

The invention also relates to a method for production of sweetened water, according to which a predefined volume of the concentrated solution and propellant from at least one cartridge according to the invention is injected in water to mineralize.

The method of the invention gives a sweetened water having a known predetermined mineral composition. Indeed, beyond the health benefits associated to minerals, the mineral composition of a water is associated to organoleptic properties and it is the purpose of the invention to produce a specific mineral water with a specific sensorial quality, mouth feel and/or flavour.

Both the solution of minerals and the propellant are injected in the water to mineralize to ensure that mineral species remain in solution. This injection does not significantly affect the pressure inside the cartridge, ensuring the stability of the concentrated mineral solution in the cartridge.

The method of the invention can be for online production of mineral water. In that case, the predefined volume of the concentrated solution is injected in a flow of water to mineralize.

Online production of mineral water refers to a process where the water flows continuously during the production. Water entering the process is the inflowing while water produced during the process is the mineral water. For example, tap water can be mineralized continuously while it is running to give mineral water, The production process is stopped when the inflow of tap water is stopped. This implies a notion of instantaneity, meaning that the inflowing water is not stored and mixed with minerals in a reservoir during a period of time to achieve dissolution. The water flows within tubing (which are not to be considered as reservoir in view of their limited volume).

The source water for the production may be tap water, natural mineral water or water from any other source having process of purification and/or undergone a preliminary demineralization.

The method of the invention can also be for mineralizing at once a volume of water, for example water standing in a reservoir.

The cartridge can be a spraying bottle, allowing the delivery of a predetermined volume of concentrated solution into the water to mineralize, be it online flowing water or standing water.

The mineral content of the water to mineralize in the process is preferably known, thereby allowing to know the mineral content of the mineralized or produced water. Preferably, the water to mineralize has a dry mineral residue below 500 mg/L, and preferably below 100 mg/L.

Preferably, the predefined volume of concentrated solution of minerals injected per volume of flowing water is comprised between 1:100 and 1:1000, preferably 1:125 and 1:800 and still preferably between 1:150 and 1:500.

In some embodiments, the method for production of sweetened water according to the invention is for domestic production of sweetened water. This implies that the amounts of water which can be produced each day is limited, like for example up to 10 L or 100 L per day, or any amount suitable for example for a restaurant. For this purpose, in the case of an online production, the method can further comprise the steps of:
An operator triggers the production of mineral water, and, when he has retrieved sufficiently,
The operator stops the online production of mineral water.
   In other embodiments, the method of the invention is for industrial production of sweetened drinkable water, meaning production of large amounts of sweetened water which can further be packaged for commercial purpose or used for production of other liquid and food products. Indeed, a specific drinkable preparation, like sodas or beer, to keep a constant flavor, has to be produced from a single type of water. Being able to produce a water with a constant composition at different locations allows to decentralize the production to several locations and limit the transport delays, costs and environmental impact.

The use of the cartridge of the invention to produce mineral water ensures that a constant amount of minerals is injected along time, within the production process. It indeed avoids stability problems in the concentrated solutions leading to possible deviation in the mineral content passing from the reservoir of concentrated solution towards the production flow.

The method for production of sweetened water according to the invention can further comprise placing the water, before or after injection of the predetermined volume of concentrated mineral solution, in presence of solid minerals. These solid minerals can be a synthetic powder and/or of aragonite, for example in a micronized form, injected or within a cartridge through which the water flow passes, a mineral column. The “term mineral column” is used to describe a filter or a cartridge comprising solid salts forming a network and that dissolve partially when water runs through said network. Advantageously, the mineral column comprises elements that have low solubility in water and that are hard to dissolve in sufficient quantities in the concentrated solution or solutions. These elements with low solubility are generally calcium and magnesium in a carbonate form. The column can for example contain dolomite, which is a mixed calcium and magnesium carbonate, or calcite, which comprises primarily calcium carbonate.

Mineral powders are preferably very fine powders, made of particles with diameters of a few microns, for example between 5 and 200 microns, that feature significant fluidity and of which the volume can be measured, in a manner very similar to that used for liquid solutions.

Aragonite is the polymorphic form, stable at high temperature and at high pressure, of calcium carbonate, the two other stable polymorphs under ambient conditions being calcite and vaterite. Marine oolitic aragonite is, in particular, found in the Bahamas and in Florida.

The term “synthetic powders” is used to describe specific mineral salts, such as calcium carbonate for example, obtained by precipitation in specific conditions that give specific dimensions and properties to the particles. For example, the article by Brečević, L. and Kralj, D. (2007; on calcium carbonates: from fundamental research to application. Croatica Chemica Acta, 80 (3-4), 467-484) reviews the techniques enabling to obtain polymorphic forms of calcium carbonate. This article describes in particular the formation of amorphous calcium carbonate, less stable than the crystalline forms (calcite, vaterite) or hydrated forms, but with a higher dissolution rate and that can advantageously be used for the implementation of the method according to the invention. Aragonite can also be obtained by a synthetic process. Synthetic powders of calcium carbonate, of magnesium carbonate, of calcium hydroxide or of magnesium hydroxide can for example be used, or a mixture thereof, preferably at least partially in an amorphous form.

Synthetic powders are therefore not micronized or ground powders such as those that can be found in industrial remineralisation systems, but powders of mineral salts, at least partially amorphous.

In some cases, the pH of the water to be mineralized being very different from the pH of the sweetened water that is to be produced, the pH of the remineralised water must be adjusted. For example, the pH of the water can be adjusted prior or at the same time as injection of the concentrated mineral solution, in order to optimise the dilution of the concentrated solution in the inflowing water and, as necessary, the elements of the mineral column.

The pH adjustment can be by acidification or basification. Acidification can for example be achieved by the injection of a volume of an acid solution or by injection of carbon dioxide, prior to remineralisation. Basification can for example be achieved by adding a volume of a basic solution.

Advantageously, gaseous carbon dioxide from the pressurized cartridge of the invention is injected in the water to mineralize, along with the concentrated solution of minerals, to lower the pH of the water and maintain the two-phase equilibrium of dissolved bicarbonates and gaseous CO₂ after discharge from the cartridge. This principle is known as bubbly flow and is characterized by a dispersion of small gas bubbles finely dispersed within a liquid matrix continuum.

This avoids solid apparition in the remineralized water and ensures a precise dosage.

There exist valves designed to discharge such a bubbly flow, like for example the ECO-Valve by Salvalco® which is arranged to sample both phase (gas and liquid) for mixed discharge.

The invention will be better understood upon reading the following description of several embodiments of the invention, with reference to the appended drawings, wherein:

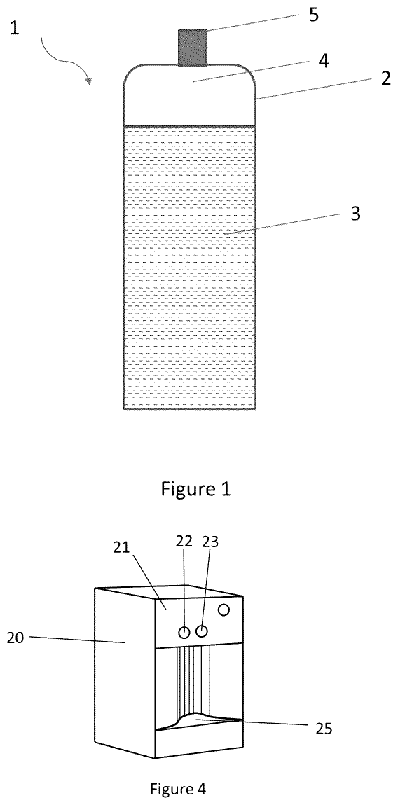

FIG. 1 is a schematic view of a cartridge according to the invention;

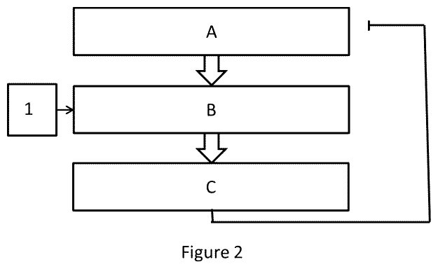

FIG. 2 is a block diagram of the method according to the invention;

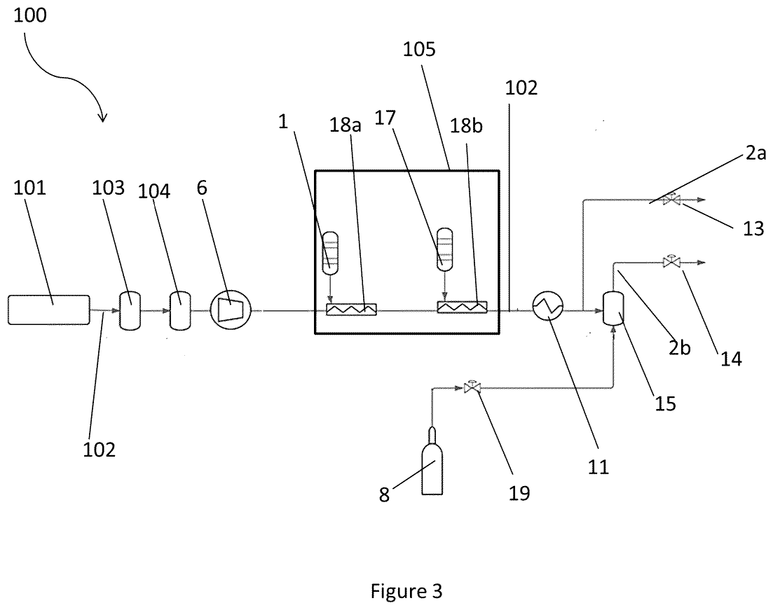

FIG. 3 is a schematic view of an appliance for operating the method according to the invention;

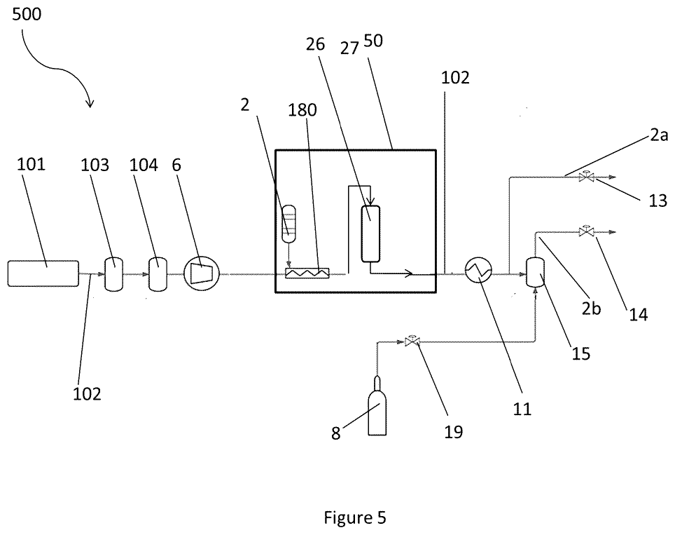

FIG. 4 is a perspective view of an appliance for operating the method according to the invention, and

FIG. 5 is a schematic view of another appliance according to the invention.

With reference to FIG. 1, a cartridge 2 contains a concentrated solution 3 of minerals occupying about 80% of the volume of the cartridge and a gas 4, under a pressure of 75 psi, in the remaining volume of the cartridge. A cartridge head with an expander is arranged at the top of the cartridge, to ensure communication with the outside of the cartridge when needed (upon opening).

The cartridge is made of any suitable material, like for example in a metallic material, able to stand high pressure content, like for a standard aerosol bottle.

Gas 4 is here pure CO₂ as compressed gas.

For the purpose of illustration, the concentrated solution 3 of minerals is here, for example, a solution comprising calcium and magnesium as described in example 1 below. The concentrated solution can however contain many more mineral species.

With reference to FIG. 2, the method of the invention for online production of sweetened water, according to which a predefined volume of the concentrated solution from the cartridge 1 of FIG. 1 is injected in the flow of water to mineralize.

During a first step A, a consumer manifests their desire for sweetened water, of predetermined composition, thereby triggering the production process. For example, here, it opens a valve or a tap letting demineralized tap water flowing through a pipe in a production unit at a determined flow rate.

During a step B, the tap water is then mineralised by injection of a predetermined volume of a concentrated solution from the cartridge 1. The expander in the head 5 can for example be coupled to a driver that opens the head for a period of time allowing the predetermined volume to exit the cartridge 1 and flow into the demineralised water.

Depending on the mineral content expected for the produced water, several cartridges containing concentrated solutions of minerals with different mineral compositions may be used in series, and/or a volume of a synthetic powder or of aragonite can be added successively to the flowing water to mineralize.

The water can also run on one or several mineral columns, this passage causing the dissolution of solid minerals of the column, for the purpose of completing the remineralisation step.

During step C, the consumer retrieves the mineralised (sweetened) water they need, for example for personal consumption, or to fill a carafe. When the consumer has retrieved the required quantity of water, the mineral water production method ends, i.e. tap water stops being supplied at the inlet valve. This implies that there is no accumulation of water during the production process. All the steps occur “in-line”, i.e. water is circulating. The continuously remineralisation must therefore be immediate.

In certain cases, carbon dioxide in a gaseous form can be injected into the circuit between step A and step C, for pH regulation purposes. This step might be necessary to facilitate the dissolution of the minerals when solid minerals are used in addition to the cartridge or to substantially acidify the water to be mineralized, when the pH of the mineral water to be produced is relatively acid and the carbonate ions cannot be only transported by dissolved species in the concentrated mineral solution.

When the inflowing water is for example tap water, before injecting any minerals, the impurities of the tap water can be eliminated to obtain purified water. The specific techniques of the purification step depend on the quality of the tap water. The purpose of the purification step is to eliminate suspended elements, residual chlorine and other components, such as heavy metals.

Also, the inflowing water can be demineralised by partial or total removal of the minerals, in order to eliminate the undesirable components that were not eliminated during the purification step. These components are mainly monovalent and bivalent ions. The demineralisation step can implement a reverse osmosis technique, which tends to eliminate the totality of the minerals, or ion-exchange resins, which enable a selective demineralisation. The choice of technique is made on the basis of the compositions of the tap water and of the mineral water to be produced. Eliminating minerals prior to remineralisation enables to better control the final mineral content of the mineral water produced.

In the case of the mineral water to be produced being sparkling water, a gasification step can be introduced after remineralisation.

Example 1: preparation of a cartridge with a concentrated solution of minerals to produce mineral water that is substantially similar to Evian water.

Table 1 details the composition of water sold under the registered trademark Evian.

TABLE 1

| Mineral | Evian |
|---|---|
| element | (ppm) |
| Ca²⁺ | 78 |
| Mg²⁺ | 24 |
| Na⁺ | 5 |
| K⁺ | 1 |
| HCO₃⁻ | 357 |
| SO₄²⁻ | 10 |
| Cl⁻ | 4.5 |
| NO₃⁻ | 3.8 |
| Total dissolved | 357 |
| matter | |
| pH | 7.2 |

The mineral elements being inaccessible in the pure ionic form, it is important to correctly select salts or anion-cation pairs.

Table 2 details the maximum solubility of common mineral salts.

TABLE 2

| | Maximum |
|---|---|
| | solubility |
| Salt | (g/100 mL) |
| Ca(HCO3)2 | 16.1 at 0° C. |
| | and 16.6 at 20° C. |
| Mg(HCO3)2 | 2.0-3.1 ^{[1]} |
| NaHCO3 | 6.9 at 0° C. |
| | and 9.6 at 20° C. |
| KHCO3 | 33.7 at (20° C.) |
| NaCl | 35.9 |
| Ca(NO3)2•4H2O | 129.0 at 20° C. |
| MgSO4•7H2O | 26.9 at 0° C. |
| | and 35.1 at 20° C. |

Within the cartridge, the concentrated solutions will be under a high pressure of carbon dioxide and will therefore contain a large amount of dissolved carbon dioxide. So, instead of dissolving directly calcium and magnesium carbonates, it is chosen to dissolve calcium and magnesium hydroxides, which will further convert into bicarbonate when place under high pressure of carbon dioxide.

Four concentrated solutions have been designed to reach the Evian® concentrations: one to deliver calcium bicarbonates to be diluted by a ratio of 1:150, one to deliver calcium bicarbonates to be diluted by a ratio of 1:387, one to deliver magnesium bicarbonates to be diluted by a ratio of 1:150 and one to deliver magnesium bicarbonates to be diluted by a ratio of 1:387.

The target concentrations of bicarbonates and hydroxide equivalents are summarized in table 3. The solutions have been prepared by adding sequentially the desired powder amount to distilled water under carbon dioxide bubbling and bringing up to the desired volume.

TABLE 3

| | Concentrate for 1:150 | | Concentrate for 1:387 | |
|---|---|---|---|---|
| | dilution | | dilution | |
| | Target | Equivalent | Target | Equivalent |
| | concentration | hydroxide | concentration | hydroxide |
| | (g/100 mL) | (g/L) | (g/100 mL) | (g/L) |
| Ca(HCO₃)₂ | 4.8 | 44.3 | 12.0 | 54.8 |
| Mg(HCO₃)₂ | 1.93 | 7.7 | 5.0 | 20.0 |

The solutions can for example additionally contain some so called “soluble salts”, like sodium bicarbonate, potassium bicarbonate and/or hydroxide, sodium chloride, calcium nitrate, magnesium sulfate, etc., in order to reproduce the composition of the Evian water.

It is also possible to obtain water similar to the water sold under the registered trademark Gerolsteiner®, having a mineral composition as disclosed in table 4.

TABLE 4

| Mineral | Gerolsteiner |
|---|---|
| element | (ppm) |
| Ca²⁺ | 348 |
| Mg²⁺ | 108 |
| Na⁺ | 118 |
| K⁺ | 10.8 |
| HCO₃⁻ | 1816 |
| SO₄²⁻ | 38.7 |
| Cl⁻ | 39.7 |
| NO₃⁻ | 5.1 |
| Total dissolved | 2488 |
| matter | |
| pH | 5.9 |

This water has a much higher magnesium and calcium content. The concentrated solution to obtain this type of water are typically much better preserved within the cartridge of the invention, with a much better stability.

Due to the carbon dioxide pressure within the cartridge, even when the cartridge will be almost empty, the carbon dioxide level within the solution, remain stable, ensuring the solubility of the mineral species over the whole shelf life of the cartridge. This opens the door to manufacturing larger volume cartridge, in order to limit the maintenance involved by the need to change cartridges.

When the concentrated solutions are injected into the flowing water to mineralize, the final pH maybe lower than the expected pH. This is due to the carbon dioxide saturation of the concentrated solution within the cartridge. It may therefore be necessary to correct the pH by, for example, bubbling air into the water to remove CO₂ or using a membrane contactor.

The steps of the method having been described, an example of the system using the cartridge of the invention is now presented.

With reference to FIG. 3, the appliance 100 comprises a connection port 101 to connect the input of the circuit 102 to the water mains. The circuit 102 passes through a cartridge 103 of granulated activated carbon, a reverse osmosis unit 104 and a remineralisation unit 105. A pump 6 is here inserted between the demineralisation unit and the remineralisation unit 105. At the output of the remineralisation unit, the circuit 102 passes through a cooling unit 11 before splitting into two sub-circuits 2a and 2b. The sub-circuit 2a leads to the outlet valve 13 of cold water and the circuit 2b passes through the gasification unit 15, connected to a carbon dioxide cylinder 8 by a valve 19, before reaching valve 14 of carbonated/sparkling cold water.

In the remineralisation unit 5, the circuit passes through a first static mixer 18a, at the input of which is connected the pressurized cartridge 1, containing a first concentrated mineral solution under CO₂ pressure. The circuit then passes through a second static mixer 18b, at the input of which is connected a second cartridge 17, containing a second concentrated mineral solution. The connection between the cartridges and the static mixers can be any suitable connection, like control valves or fluidic microfeeding devices to dispense metered micro-volumes of the concentrated solutions in combination with a proportion of propellant gas, depending on the flow rate of the water passing through it. The frequency at which the concentrated solution is dispensed and the dispensed volume are predetermined based on the circulation flow rate of the water that is to be remineralised.

With reference to FIG. 4, in the case the cartridge of the invention is used in a domestic appliance, all the elements of the appliance can be contained in a casing 20, featuring at its surface a connection port 1 (not shown), preferably at the rear of the casing, and a control panel 21, on the front of the casing, whereon are arranged a control button 22 for cooled or cold still water and a control button 23 for cold sparkling water. The front of the casing comprises a reinforcement forming a platform 25. The cartridge 2 is typically enclosed within the casing 20.

A user or a consumer can place a glass on the platform 25 of the appliance and initiate the production of water by pressing on one of the buttons 22 to 24, depending on their selection. The connection port 1, in this case a solenoid valve, opens to let tap water into the circuit.

The tap water first runs through the cartridge 103 of granulated activated carbon where it is purified by the removal of residual chlorine and other pollutants such as lead. A micron filter (not shown) is associated with this cartridge in order to eliminate all the particles potentially suspended in the tap water.

The water thus purified then passes through the unit 104 comprising one or several reverse osmosis cartridges, enabling the water to be rid of 99.5% of its minerals. The pump 6, placed downstream from the demineralisation unit 104, causes the water to flow and generates the pressure difference required for the reverse osmosis cartridges to function.

The demineralised water then enters the remineralisation unit 5. The cartridges containing the concentrated mineral solutions are activated as soon as a stream of water appears in the circuit, i.e. as soon as the inlet valve 1 opens. The microfeeding device thus injects in the circuit 102 a flow/stream of the concentrated mineral solutions, together with a certain volume of propellant, contained in the cartridges, either continuously, or in the form of micro-volumes dispensed at regular intervals. The volume of propellant dispensed along with the concentrated solution will depend on the microfeeding system, as generally known to a person skilled in the art. The microfeeding device preferably is selected to enable to manage flow rates in the range of some microliters per second with a great degree of accuracy. The concentrated solution and the propellant are mixed with the demineralised water at the level of the static mixers 18a and 18b, in this case a helical insert, which creates sufficient turbulence in the circuit 102 to homogenise the remineralised water, without causing the salts to precipitate.

After remineralisation, depending on the initial choice of the consumer, the water is sent to one of the outlet valves 13 or 14.

If the user has pressed on button 22 to obtain cold still water, valve 13 is opened. The stream of water passes through an aluminium thermoelectric module enabling the cooling of the water to between 5° C. and 10° C. The cooled water then follows the sub-circuit 2a before exiting through the valve 13.

If the user has pressed on button 23, valve 14 is opened. As described above, the water is first cooled and then passes through a carbonator 15 wherein high-pressure gaseous carbon dioxide is injected into it. The flow of carbon dioxide is controlled by the valve 19 and is injected, either continuously or by pulses at regular intervals. The carbon dioxide dissolves in the cooled sweetened water before leaving the sub-circuit 2b through valve 14.

The outputs corresponding to the valves 13 and 14 are preferably pipes that are either joined to form a single opening or juxtaposed, on top of the platform 25. Their opening is arranged vertically downwards so that the produced water falls into the glass placed by the consumer on the platform.

The production being immediate, pressure on one of the command buttons simultaneously causes the opening of the inlet valve 1 and of one of the outlet valves 13 or 14.

With reference to FIG. 5, an appliance 500 can comprise a remineralisation unit 50 that is slightly different from that described for the appliance 100. The circuit 102 here passes through a static mixer 180, at the input of which is connected the cartridge 2 containing a concentrated mineral solution under pressure of propellant gas. The concentrated mineral solution does not, in this instance, provide the totality of the mineral element to the inflowing water. The circuit then passes through a salt column 26, which can for example be constituted of dolomite, in the form of powder or balls. Magnesium, calcium and carbonate dissolve due to the passage of a stream of water. This is a hybrid system.

The different elements of the appliance are preferably arranged to minimise the overall volume of the circuit and to avoid dead spaces. Indeed, these dead spaces are conducive to the development of algae or bacteria, which is not desirable.

The different elements of the appliance can be replaced by any other element or system serving the same purpose and achieving the same result.

The demineralisation step can, for example, also be achieved with an ion-exchange resin cartridge. An ion-exchange resin, generally with zeolites and polymers featuring ion groups on their chains, enable to substitute a type of ion, for example sodium cations, for another type of ion, for example calcium cations. Depending on the resin or the mixture of resin used, one or several types of ion can be substituted, thus enabling selective demineralisation.

Remineralisation has been described with a single concentrated mineral solution or two concentrated mineral solutions provided under a pressure of propellant gas containing CO₂ in cartridges. However, it may also happen, in certain cases, that it is impossible, for reasons of saturation for example, to dissolve in a sufficiently concentrated manner, all the elements that are to be added. In this case, the mineral elements to be added are separated into more concentrated solutions, having the same composition or different compositions, and/or fine synthetic powders and/or aragonite.

Alternatively, if a single concentrated solution is required, the second cartridge can also be filled with this solution and used when the first one is empty, thereby doubling the capacity of the appliance in terms of the concentrated solution.

The cartridge of the invention can typically be a reusable container, which can be refilled and reused many times.

A complex system of mineralization of tap water has been exemplified above. However, the pressurized cartridge of the invention can be used in any other mineralization apparatus, like known domestic apparatus for producing sparkling water and/or water with specific tastes. In this case, the water to remineralize is for example provided in a reservoir, which can be refilled.

It is even possible to use the cartridge as such with a specific dosing mechanism. In that case, the production of mineral water is not “online” but more static. A user could use the cartridge to inject a volume of mineral concentrated solution and propellant in a bottle of a specific volume, like for example in a 1L bottle. The cartridge can for example be provided as a spray, arranged to deliver a given quantity of concentrated mineral solution upon pression on the spray head. Any other suitable arrangement is also possible.

What is claimed is:

1-15. (canceled)

16. A pressurized cartridge comprising a concentrated solution of minerals under a pressure of propellant gas comprising CO₂.

17. The pressurized cartridge according to claim 16, wherein the concentrated solution of minerals contains at least a sparingly soluble salt, wherein the sparingly soluble salt is at a supersaturation concentration, or at a saturation concentration, or the sparingly soluble salt is close to its saturation concentration.

18. The pressurized cartridge according to claim 17, wherein the sparingly soluble salt is a mineral bicarbonate species.

19. The pressurized cartridge according to claim 16, wherein the pressure in the cartridge is between 35 psi and 100 psi.

20. The pressurized cartridge according to claim 16, wherein the concentrated solution of minerals comprises at least a dissolved calcium, and/or a magnesium salt, preferably a bicarbonate salt.

21. The pressurized cartridge according to claim 16, wherein the propellant gas is CO₂.

22. The pressurized cartridge according to claim 16, wherein the concentrated solution of minerals comprises at least one salt selected from magnesium sulfate (MgSO₄), magnesium bicarbonate (Mg(HCO₃)₂), magnesium nitrate (MgNO₃), calcium nitrate (Ca(NO₃)₂), calcium bicarbonate (Ca(HCO₃)₂), sodium chloride (NaCl), sodium bicarbonate (NaHCO₃), and potassium bicarbonate (KHCO₃).

23. A method for producing mineralized water, comprising
i. pressurizing a cartridge comprising a concentrated solution of minerals under a pressure of propellant gas comprising CO₂, and
ii. introducing the pressurized cartridge to water to produce the mineralized water.

24. A method for producing mineralized water, comprising injecting into water a predefined volume of a concentrated solution of minerals, and a propellant from the cartridge according to claim 16 to produce mineralized water.

25. The method according to claim 24, wherein the water to mineralize has a dry mineral residue below 500 mg/L.

26. The method according to claim 24, wherein the predefined volume of concentrated solution and propellant injected per volume of water to mineralize is between 1:100 and 1:1000.

27. The method according to claim 24, further comprising placing the water, before or after injection of the predetermined volume of concentrated solution and propellant, in the presence of solid minerals.

28. The method according to claim 24, further comprising online production of sweetened water wherein the predefined volume of the concentrated solution and propellant is injected in a flow of water to mineralize.

29. The method according to claim 24, wherein the predefined volume of the concentrated solution and propellant is injected in a reservoir of water to mineralize.

30. The method according to claim 24, wherein the predefined volume of the concentrated solution and propellant is injected in water to mineralize as a bubbly flow.
